(19) United States
(12) Patent Application Publication
(10) Pub. No.: US 2017/0219532 A1
(43) Pub. Date: Aug. 3, 2017

(54) GUIDED WAVE PHASED ARRAY BEAMFORMING

(71) Applicant: University of South Carolina, Columbia, SC (US)

(72) Inventors: Lingyu Yu, Irmo, SC (US); Zhenhua Tian, Columbia, SC (US)

(21) Appl. No.: 15/420,341

(22) Filed: Jan. 31, 2017

Related U.S. Application Data
(60) Provisional application No. 62/289,409, filed on Feb. 1, 2016.

(51) Int. Cl. G01N 29/24; G01N 29/28; G01N 29/12

(52) U.S. Cl. CPC G01N 29/2418; G01N 29/12; G01N 29/28

(57) ABSTRACT

Systems and methods for evaluating an anisotropic composite material are provided. In one example implementation, a system includes a guided wave source configured to provide one or more guided waves to the anisotropic composite material. The system includes at least one sensor configured to measure a property of the one or more guided waves in the anisotropic composite material. The system includes one or more processors configured to receive output signals from the at least one sensor. The one or more processors are configured to construct a phased array of a plurality of output signals associated with different locations on the anisotropic composite material. The one or more processors are configured to generate a directional output beam associated with phased array based at least in part on a direction dependent guided wave parameter.

### PRIORITY CLAIM

The present application claims the benefit of priority of U.S. Provisional Application Ser. No. 62/289,409, filed Feb. 1, 2016, titled “Guided Wave Phased Array Beamforming,” which is incorporated herein by reference for all purposes.

### FIELD

The present disclosure relates generally to guided wave beamforming and more particularly to phased array beamforming using guided waves in anisotropic composite materials.

### BACKGROUND

Nondestructive evaluation (NDE) techniques can be used, for instance, in the aerospace industry to ensure operational ability and safety related to various structural components. For instance, ultrasonic NDE techniques can be used to inspect the condition of a structural component. Ultrasonic NDE is directly sensitive to mechanical changes and can be used to directly assess the mechanical condition and integrity of the structure.

Conventional NDE techniques use bulk waves to inspect such structures. However, using bulk waves can require a point-by-point measurement of the inspected area, which can be time-consuming and inefficient. To address such inefficiencies, guided wave-based ultrasonic NDE techniques have been introduced. Guided waves can travel long distances within waveguides with low energy loss. However, conventional guided wave-based techniques may be inaccurate when used on anisotropic composite materials. For instance, guided wave parameters, such as wavenumbers, phase velocities, and group velocities are direction dependent in composite materials due to the direction dependent physical properties of the composite materials. Further, the guided waves can have an energy skew in such composite materials because the direction of the group velocity may not be aligned with that of the phase velocity. Further still, wave fronts of guided waves in composite materials may not be circular, adding complexity to the guided wave propagation.

### SUMMARY

Aspects and advantages of the invention will be set forth in part in the following description, or may be obvious from the description, or may be learned through practice of the invention.

One example aspect of the present disclosure is directed to a system for evaluating an anisotropic composite material. The system includes a guided wave source configured to provide one or more guided waves to the anisotropic composite material. The system includes a function generator configured to provide one or more signals to the guided wave source to generate the one or more guided waves. The system includes at least one sensor configured to measure a property of the one or more guided waves in the anisotropic composite material. The system includes one or more processors configured to receive output signals from the at least one sensor associated with measured properties of the one or more guided waves. The one or more processors are configured to construct a phased array of a plurality of output signals associated with different locations on the anisotropic composite material. The one or more processors can be configured to generate a directional output beam associated with phased array based at least in part on a direction dependent guided wave parameter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a schematic of an example geometric relation of guided waves generated by sources at different locations according to example embodiments of the present disclosure;

FIG. 2 depicts a schematic of example geometric relations between the wavenumber vector k and the group velocity vector c_{g} according to example embodiments of the present disclosure;

FIG. 3 depicts an example phased array configuration according to example embodiments of the present disclosure;

FIG. 4 depicts an example beamforming factor image according to example embodiments of the present disclosure;

FIG. 5 depicts an example beamforming factor image according to example embodiments of the present disclosure;

FIG. 6 depicts an example beamforming factor image according to example embodiments of the present disclosure;

FIG. 7 depicts a plot of an example beam pattern according to example embodiments of the present disclosure;

FIG. 8 depicts a plot of an example beam pattern according to example embodiments of the present disclosure;

FIG. 9A depicts an example system for evaluating composite materials according to example embodiments of the present disclosure;

FIG. 9B depicts an example anisotropic composite material according to example embodiments of the present disclosures.

FIGS. 10A, 10B, 10C and 10D depict example wavefield measurements according to example embodiments of the present disclosure; and

FIGS. 11A and 11B depicts example imaging results according to example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to guided wave beamforming in anisotropic laminated composite materials. In some implementations, a phased array having a plurality of array elements arranged in a grid (e.g., a rectangular grid) can be used to produce guided wave signals that propagate through a composite plate. The output “beam” of the phased array can be determined using delay-and-sum techniques. The output beam can be formed using direction dependent guided wave parameters. In some implementations, the delays can be implemented in the phase domain, and can be determined by maximizing the array output at a desired direction. The beamforming further considers the energy skew effect associated with the propagation of the guided waves through the composite material.

In particular, the beamforming can be determined based at least in part on the array directional pattern and/or the wavenumber distribution of the output of the phased array. For instance, in implementations wherein the wavenumber distribution is used, the distribution of a beamforming factor in the wavenumber domain can be identified, and the dispersion curves of the waves can be matched to the wavenumber maxima. The beamforming factors can further be dependent on the configuration of the phased array. In particular, the beamforming can be dependent on element spacing and the span of the phased array.

For example, in one implementation, a system can include a guided wave source configured to provide one or more guided waves to the anisotropic composite material, such as a carbon reinforced composite material. The system can include a function generator configured to provide one or more signals to the guided wave source to generate the one or more guided waves. The system can include at least one sensor configured to measure a property of the one or more guided waves in the anisotropic composite material. The system can include one or more processors configured to receive output signals from the at least one sensor associated with measured properties of the one or more guided waves. The one or more processors can be configured to construct a phased array of a plurality of output signals associated with different locations on the anisotropic composite material. The one or more processors can be configured to generate a directional output beam associated with phased array based at least in part on a direction dependent guided wave parameter.

In some embodiments, the phased array can be a rectangular array. However, other suitable configurations of the phased array are contemplated by the present disclosure. In some embodiments, the sensor can be a scanning laser Doppler vibrometer that is configured to measure a guided wave velocity along a laser beam. However, other suitable sensors can be used without deviating from the scope of the present disclosure.

In some embodiments, the one or more processors are configured to generate a directional output beam at least in part by implementing a delay in the one or more output signals. The delay can be a time delay in the time domain. The delay can be a phase shift in the phase domain. In some embodiments, the one or more processors are configured to generate a directional output beam by implementing a weighting factor in the one or more output signals. In some embodiments, the one or more processors are configured to generate a directional output beam by implementing a beam forming factor in the one or more output signals.

In some embodiments, the guided wave source can be a lead zerconate titinate (PZT) material. In some embodiments, the function generator can be configured to provide a signal with a frequency of about 120 kHz to the guided wave source. In some embodiments, the sensor can be configured to measure a property associated with a reflection wave reflected from a defect in the anisotropic composite material.

Another example aspect of the present disclosure is directed to a method of evaluating an anisotropic composite material. The method can include providing one or more guided waves through an anisotropic composite material. The method can include obtaining output signals from at least one sensor. The output signals can be associated with measured properties of the one or more guided waves. Each output signal can be associated with a different location on the anisotropic composite material to form a phased array (e.g., a rectangular phased array) of a plurality of output signals. The method can include implementing a delay in one or more of the output signals to generate the directional output beam for the phased array.

In some embodiments, the delay can be implemented as a time delay in the time domain. In some embodiments, the delay can be implemented as a phase shift in the phase domain. In some embodiments, the method can include implementing a weighting factor and/or a beamforming factor in the one or more output signals to generate the directional output beam. In some embodiments, one or more of the output signals are associated with a property of a reflection wave reflected from a defect in the anisotropic composite material.

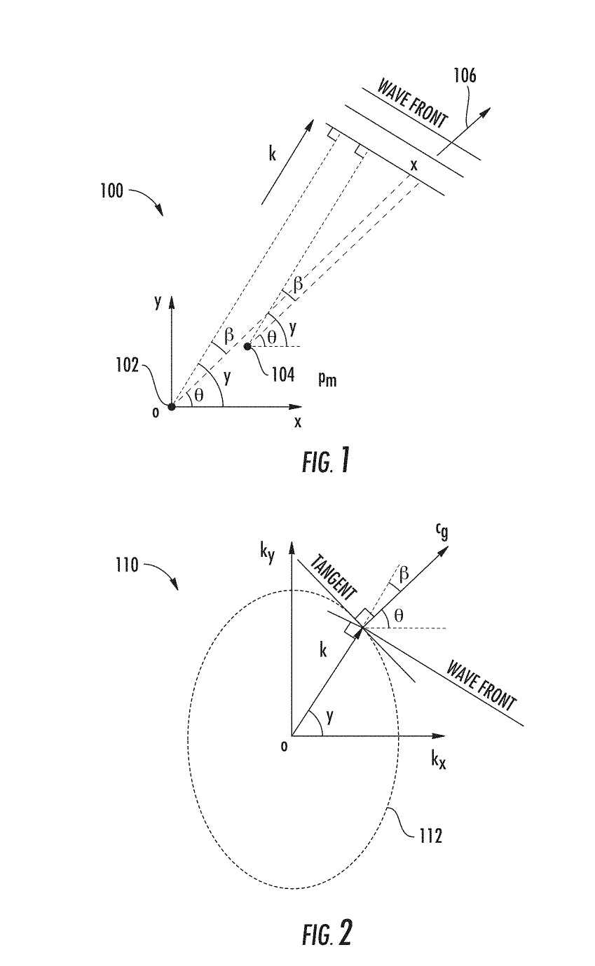

With reference now to the FIGS., example aspects of the present disclosure will be discussed in more detail. For instance, FIG. 1 is directed to a schematic 100 of example geometric relations of guided waves in composite materials generated by sources at different locations according to example embodiments of the present disclosure. In particular, when a guided wave with frequency ω and wavenumber k is generated from a source 102 at coordinate O in a composite laminate, the wave arriving at the location x that some distance from the source O can be expressed as:

u(t,x)=Ae^{j(ωt-k·x)}

where A is the amplitude, independent of wave frequency. With the geometric relations depicted in FIG. 1, it follows that:

k·x=|k∥x|cos β=k(γ)|x|cos β

with β being the angle between the wave propagation direction 106 and wavenumber k. Accordingly:

u(t,x)=Ae^{j[ωt-k(γ)|x|cos β]}

For a source located at location 104 (coordinate pₘ), the resulting wave at location x can be defined as:

uₘ(t,x)=Ae^{j[ωt-k·(x-p}^{ₘ}^{)]}

In anisotropic composite materials (e.g. composite laminates), guided wave parameters, such as wavenumbers, phase velocities, and group velocities are direction dependent, due to the direction dependent properties of the composite materials.

FIG. 2 depicts a schematic 110 of example geometric relations between the wavenumber vector k and the group velocity vector c_{g} according to example embodiments of the present disclosure. As shown, the wavenumber vector k is perpendicular to the wave front, and the group velocity vector c_{g} is orthogonal to the wavenumber curve 112 (k(γ)). The angle of the given wavenumber vector k is γ, referred to as the wavenumber angle. The angle of the group velocity vector c_{g} is θ, referred to as the group velocity angle (or energy propagation angle). The angle β between the energy propagation angle and the wavenumber angle is the skew angle (e.g. β=γ−θ). In this manner, when c_{g} is not parallel to k, skew angle β is not zero, and accordingly, the wave energy propagation direction is not perpendicular to the wave front.

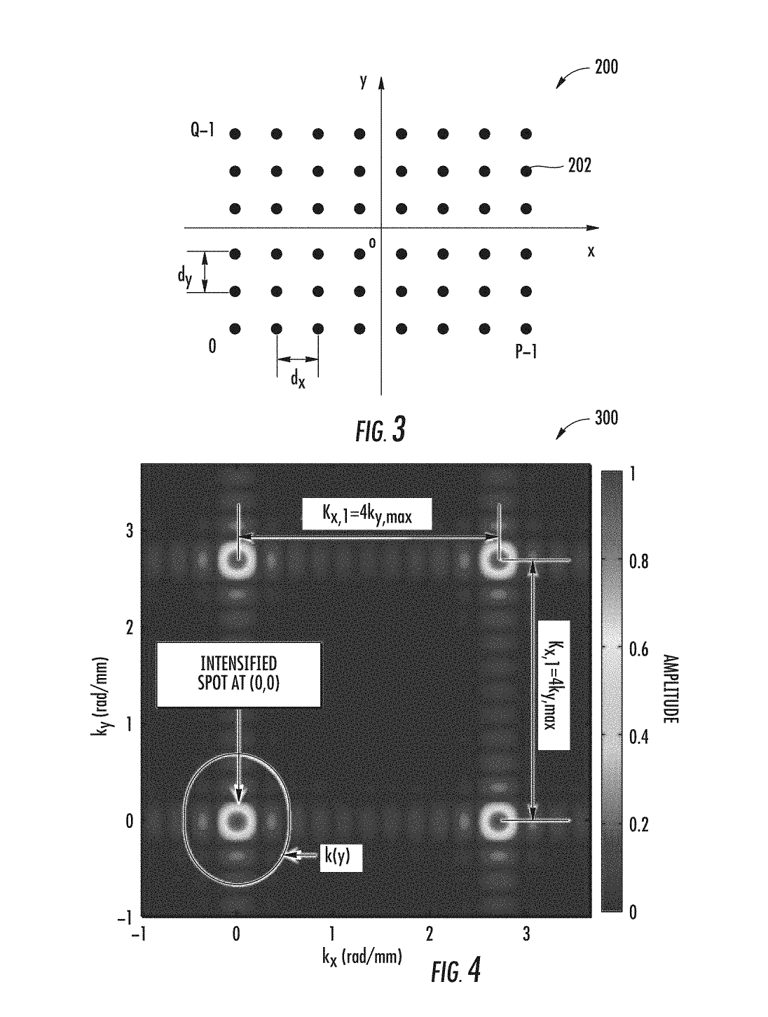

FIG. 3 depicts an example rectangular phased array 200 according to example embodiments of the present disclosure. In particular, FIG. 3 depicts a P×Q array, having a total number of M elements 202 (M=P×Q), with its phase center as the coordinate origin O. The coordinates of the (p,q)^{th} can be defined as:

$${p}_{p , q} = ( ( p - \frac{P - 1}{2} ) {d}_{x} , ( q - \frac{Q - 1}{2} ) {d}_{y} )$$

where dₓ and dₓ are array spacings in the x and y directions, respectively. The spans of the array 200 in the x and y directions can be defined as:

Dₓ=(P−1)dₓ and D_{y}=(Q−1)d_{y}

In some implementations, each element 202 of the array 210 can serve as a wave source/measurement. When each element generates waves/measures waves having frequency ω and wavenumber vector k simultaneously, the total output of the array at location x can be expressed as:

$$z ( t , x ) = {\sum }_{m = 0}^{M - 1} {Ae}^{j [ w - k \cdot ( x - {p}_{x} ) ]} = u ( t , x ) {\sum }_{m = 0}^{M - 1} {e}^{jk - {p}_{x}}$$

Such generated wave can be an amplification of the wave emitting from the origin O and the amplification can be controlled by the individual exponential components, which can be maximized when the exponent becomes zero, by applying an appropriate delay Δₘ:

$${e}^{j ( k \cdot {p}_{x} - {α}_{x} )} = {e}^{j 0} if {Δ}_{m} = k \cdot {p}_{x}$$

As shown, the delay is dependent to the m^{th} element position vector pₘ and the wavenumber vector k. In this manner, a directional beam can be generated such that the total output z (t,x) of the array is maximized at a certain direction and otherwise minimized. In various implementations, the delay can be implemented through a time delay in the time domain or a phase shift in the frequency domain.

In addition to the delay, a weighting factor wₘ can be applied to wave to further control the quality of the beamforming. For instance, a weighting factor can affect the mainbeam shape in the desired direction and sidelobe levels in other directions. In this manner, the beamforming can be expressed as:

$$z ( t , x ) = u ( t , x ) {\sum }_{m = 0}^{M - 1} {w}_{m} {e}^{j ( k , {p}_{x} - {Δ}_{x} )}$$

A beamforming factor BF can be introduced to the beamforming equation. For instance, assume the array output is directed toward a specific direction θₛ and the corresponding delay is denoted as Δm(θs). The beamforming factor BF can be represented as:

$$BF = \frac{1}{M} {\sum }_{m = 0}^{M - 1} {w}_{m} {e}^{j [ k \cdot {p}_{x} - {Δ}_{m} ( {θ}_{s} ) ]}$$

In this manner, the beamforming can be rewritten as:

z(t,x)=M·u(t,x)·BF

As indicated, to maximize the beamforming factor BF, in the desired direction θₛ, the delay should be selected to result in a zero exponent. The wavenumber vector k depends on the wave frequency ω and the wavenumber angle γₛ that corresponds to the wave energy steering angle θₛ. Accordingly, k can be expressed as k(ω, γₛ). The phase delay to direct the array output to the direction θₛ can be defined as:

Δₘ(θ_{S})=k(ω,θ_{S}+β_{S})·pₘ

The beamforming factor BF can then be expressed as:

$$BF ( k \vert {w}_{m} , {θ}_{s} ) = \frac{1}{M} {\sum }_{m = 0}^{M - 1} {w}_{m} {e}^{j [ k - k ( ω , {θ}_{s} + {β}_{ɛ} ) ] {p}_{x}}$$

In this manner, θₛ and wₘ represent the two parameters that can control the beamforming direction and beam shape of the phased array. For two-dimensional guided waves, the beamforming factor can evaluate the beamforming result at any wavenumber vector k in the kₓ-k_{y} wavenumber plane.

As indicated above, the beamforming can also be represented as a function of the wave energy propagation angle θₛ. For instance, the beamforming factor can be represented as follows:

$$BF ( θ \vert {w}_{m} , {θ}_{s} ) = \frac{1}{M} {\sum }_{m = 0}^{M - 1} {w}_{m} {e}^{j [ k ( ω , θ + β ) - k ( ω , {β}_{ɛ} + {β}_{s} ) ] {p}_{x}}$$

where k(ω, θ+β) is the wavenumber dispersion relation of the guided waves. In such representation, the beamforming factor BF evaluates the beamforming output relating to the wave energy propagation angle θ for the guided waves having wavenumber dispersion relation k(ω, θ+β). Accordingly, the beamforming factor BF can be indicative of the phased array's directional beamforming pattern.

It will be appreciated that the elements in the phased array can be configured and/or arranged in various manners. For instance, in some implementations, the phased array can be a linear array, a rectangular array, a spiral array, etc. In addition, the phased array can have various suitable numbers of elements with various suitable spacings. The composite material can be any suitable composite material, such as a carbon fiber reinforced polymer composite plate. In some implementations, the signal used for beamforming can be an A₀ lamb mode signal at 120 kHz.

The beamforming factor BF of array 200 can be represented as:

$$BF ( k \vert {w}_{p , q} , {θ}_{s} ) = \frac{1}{( \frac{{D}_{x}}{{d}_{x}} + 1 ) ( \frac{{D}_{y}}{{d}_{y}} + 1 )} {\sum }_{p = 0}^{\frac{{D}_{x}}{{d}_{x}}} {\sum }_{q = 0}^{\frac{{D}_{y}}{{d}_{y}}} {w}_{p , q} {e}^{j ( k - k ( ω , {θ}_{s} + {β}_{ɛ} ) ) ( {pd}_{x} - \frac{{D}_{x}}{2} , {qd}_{y} - \frac{{D}_{y}}{2} )}$$

As shown, the beamforming factor BF is determined based at least in part on the weighting factor w_{p,q}, the steering direction θₛ, and the array geometrical properties dₓ, d_{y}, Dₓ, and D_{y}.

FIG. 4 depicts a plot 300 of a beamforming factor according to example embodiments of the present disclosure. In particular, plot 300 depicts a beamforming factor without applying delays as an intensity image in the kₓ-k_{y} wavenumber plane. The four highlighted portions represent local maxima of the beamforming factor, such that when the array generates guided waves with wavenumbers at these local maxima, the array's output will be optimized. FIG. 4 also depicts a plot of the wavenumber curve k(γ) of the 120 kHz A₀ mode in the composite plate. As shown, no maxima of the beamforming factor falls on the wavenumber curve of the wave mode. Accordingly, if the array generates the 120 kHz A₀ mode without delaying, the array will not have maximized output.

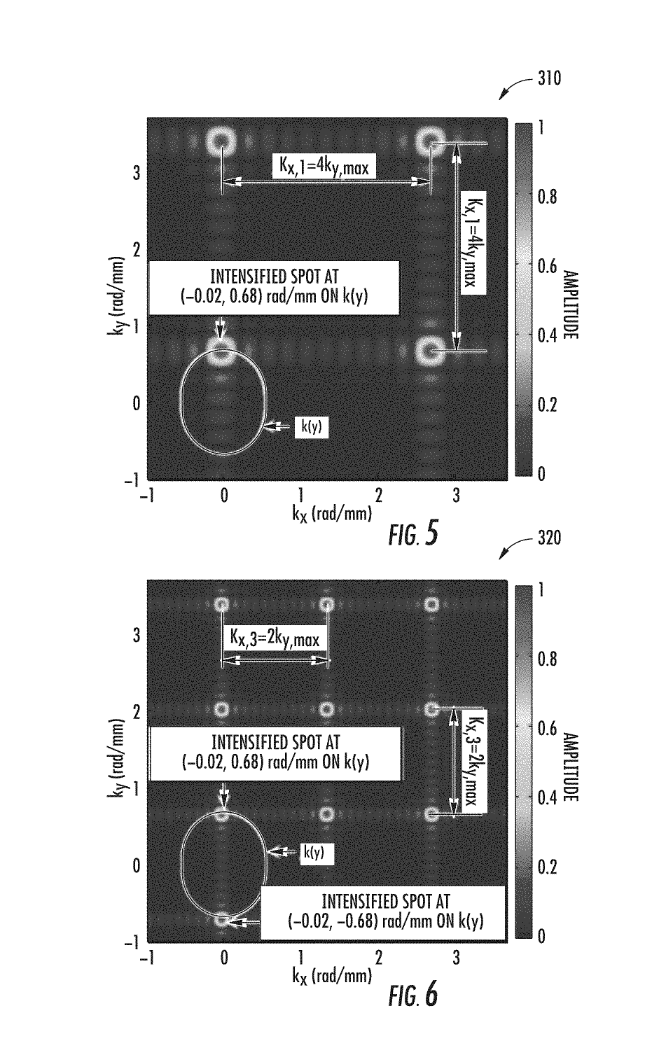

FIG. 5 depicts a plot 310 of an example beamforming factor of an array with the application of phase delays at (−0.02, 0.68) p_{p,q}. The delays are selected such that the local maxima located at (0,0) before the delays moves to the point (−0.02, 0.68) rad/mm on the wavenumber curve.

The wavenumber periods can affect the beamforming performance. For instance, FIG. 6 depicts a plot 320 of an example beamforming factor of an array according to example embodiments of the present disclosure. As shown, plot 320 depicts two intensified or highlighted portions on the wavenumber curve k(γ). Accordingly, if an array generates the 120 kHz A₀ mode with the phase delays (−0.02, 0.68) p_{p,q} the synthetic waves generated from the array will have two intensified components: waves with the wavenumber (−0.02, 0.68) rad/mm, and waves with the wavenumber (−0.02, −0.68) rad/mm. This can serve to contradict the single beam intention. In this manner, an array producing more than one intensified component may give a misleading beamforming result. Therefore, the wavenumber periods, in some embodiments, should satisfy Kₓ>2k_{x, max} and K_{y}>2k_{y, max}. In this manner, the array spacings should satisfy dₓ<λ_{x, min}/2 and d_{y}<λ_{y, min}/2.

As indicated above, the beamforming can also be defined and/or evaluated in terms of the directional beam pattern associated with the phased array. For instance, the beamforming factor BF for array 200 of FIG. 3 can be defined as:

$$\begin{matrix}BF ( θ ) {w}_{p , q} {θ}_{s} ) = \frac{1}{PQ} {\sum }_{p = 0}^{P - 1} {\sum }_{q = 0}^{Q - 1} {w}_{p , q} {e}^{j [ k ( ω , θ + β ) - k ( ω , {θ}_{x} + {β}_{s} ) ] ( p - \frac{P - 1}{2} ) {d}_{x} , ( q - \frac{Q - 1}{2} {d}_{y} )} & \\ or as \text{:} & \\ \begin{matrix}BF ( θ ) {w}_{p , q} {θ}_{s} ) = \frac{1}{( \frac{{D}_{x}}{{d}_{x}} + 1 ) ( \frac{{D}_{y}}{{d}_{y}} + 1 )} \\ {\sum }_{p = 0}^{\frac{{D}_{x}}{{d}_{x}}} {\sum }_{q = 0}^{\frac{{D}_{y}}{{d}_{y}}} {w}_{p , q} {e}^{j [ k ( ω , θ + β ) - k ( ω , {θ}_{s} + {β}_{s} ) ] ( {pd}_{x} - \frac{{D}_{x}}{2} , {qd}_{y} - \frac{{D}_{y}}{2} )}\end{matrix} & \end{matrix}$$

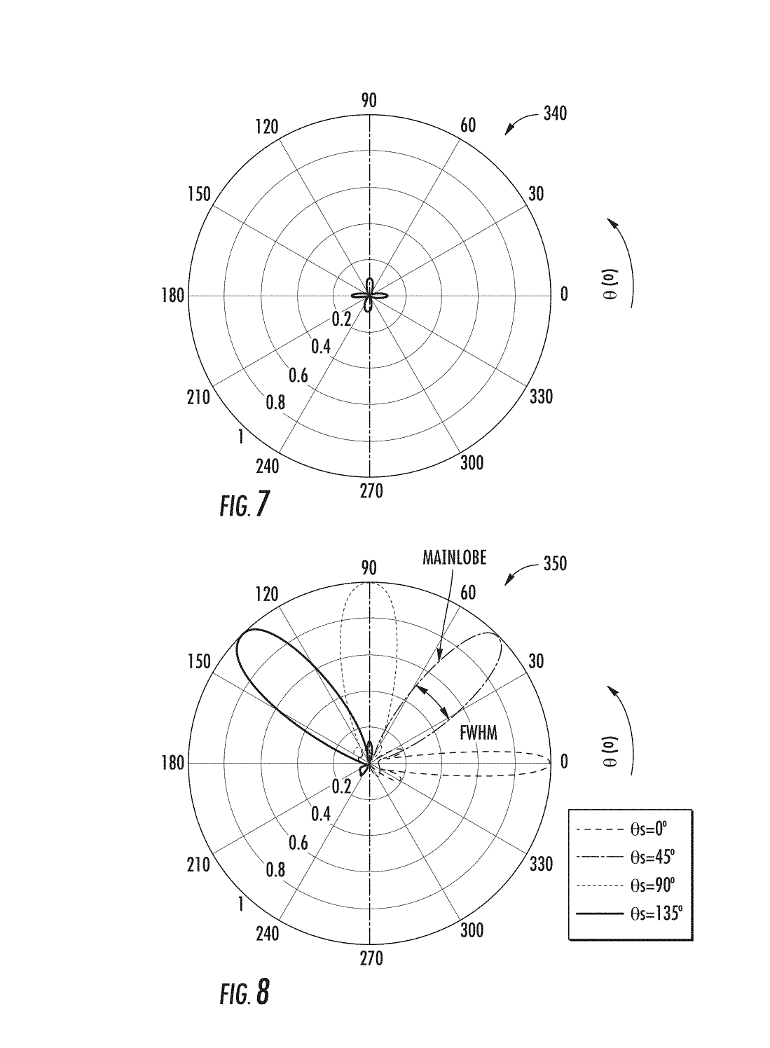

FIG. 7 depicts a directional beam pattern 340 of an array using the 120 kHz A₀ mode without applying the delays. As shown, the amplitude of pattern 340 is low in all directions. This corresponds to plot 300 of FIG. 4 wherein no maxima are located on the dispersion curve of A₀ mode.

According to example embodiments, a suitable phase delay can be applied to maximize the amplitude to a desired direction θₛ. For instance, FIG. 8 depicts a directional beam pattern 350 with beamsteering in the 0 degree, 45 degree, 90 degree, and 135 degree directions. In particular, the beamsteering can be accomplished by applying delays of (0.55, (−0.02) p_{p,q}, (0.37, 0.51) p_{p,q}, (−0.02, 0.68) p_{p,q}, and (−0.37, 0.54) p_{p,q} respectively.

To evaluate the beamforming qualities at different directions, the full width at one-half peak values (FWHM) can be determined. Smaller FWHM values can signify higher resolution as well as better directionality.

FIG. 9 depicts a system 400 for guided wave sensing in a composite plate 450. The composite plate 450 can be, for instance, an 8-ply [0/45/90/−45], ₛ layup CFRP composite plate with 2.54 mm thickness. The system includes a guided wave source 420. In some embodiments, a PZT wafer (AFPC 851: 7 mm diameter, 0.2 mm thickness) is installed as the guided wave source 420 to generate the guided waves. The PZT center can be set as the coordinate origin. The guided waves can excited by signal from a function generator 404. For instance a 3-cycle toneburst at about 120 kHz generated from a function generator 404 and amplified to about 30V by a voltage amplifier. As used herein, the use of the term “about” in conjunction with a numerical value refers to within 25% of the stated numerical value.

The system 400 can include at least one sensor 410 configured to obtain output signals indicative of guided wave properties in the anisotropic materials for a plurality of different locations on the anisotropic composite material to form the phased array. In some embodiments, a non-contact scanning laser Doppler vibrometer (SLDV) is used to acquire the velocity wavefield of guided waves over a 45 mm×45 mm scanning area centered at the coordinate origin from the back side of the plate. The horizontal and vertical spatial resolutions of the scanning are both about 0.1 mm. Based on the Doppler Effect, the SLDV measures the guided wave velocity v(t,x) along the laser beam over the scanning area, as a function of both time t and space x. In the test, the laser beam is set normal to the plate such that the out-of-plane velocity is acquired. The phased array is then constructed using SLDV scanning points at selected locations.

As shown in FIG. 9B, four identical defects can be simulated by bonding quartz rods 460 of 10 mm high and 8 mm diameter (Q1, Q2, Q3, and Q4) on the surface of the composite plate 450 a angles of 0, 45, 90, and 135 degrees. All rods are placed 100 mm to the coordinate origin associated with the PZT 420.

From the time space wavefield acquired by the SLDV, the signal at the m^{th} array point (p) can be denoted as vₘ(t)=v(t,pₘ). It frequency spectrum can be derived using the Fourier transform as follows:

Vₘ(ω)= [symbol] [vₘ(t)]=∫_{-∞}^{∞}vₘ(t)e^{-jωt}dt

Using the frequency spectrum Vₘ(w), we can derive the beamforming of the array in frequency space representation Z(ω, x):

Z(ω,x)=Σₘ₌₀^{M=1}wₘVₘ(ω)e^{j[-φ(ω,x)-Δ}^{ₘ}^{(ω,x)]}

where,

Δₘ(ω,x)=k(ω,γ)·pₘ, and φ(ω,x)=−2k(ω,γ)·x

Δₘ(ω, x) is the phase delay applied to the m^{th} array point for beamsteering, φ(ω, x) represents the spatial phase shift, and k(ω, γ) is the wavenumber vector at the frequency ω and the wavenumber angle γ, which is obtained from the wavenumber dispersion curve. As guided waves travel from the PZT to the defect and then back to the array, they undergo a phase shift φ(ω, x). Thus, −φ(ω, x) is applied in order to compensate for such spatial phase shift. In k(ω, γ), the wavenumber angle γ is determined from the geometry relation γ=θ+β.

Using the inverse Fourier transform, the frequency-space representation Z(ω, x) can be transformed back to the time-space domain as follows:

$$z ( t , x ) = {- 1}^{} [ Z ( ω , x ) ] = \frac{1}{2 π} {\int }_{- ∞}^{∞} Z ( ω , x ) {e}^{jwd} d ω$$

where z(t, x) represents the array beamforming in time-space representation.

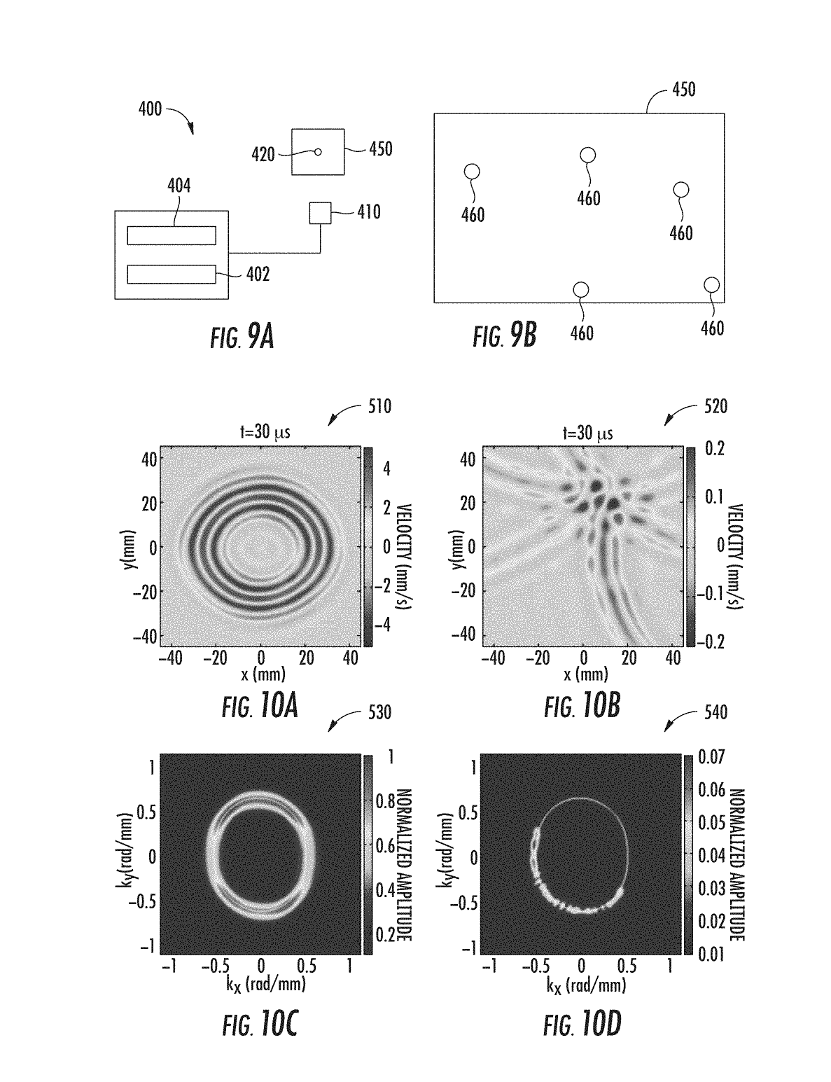

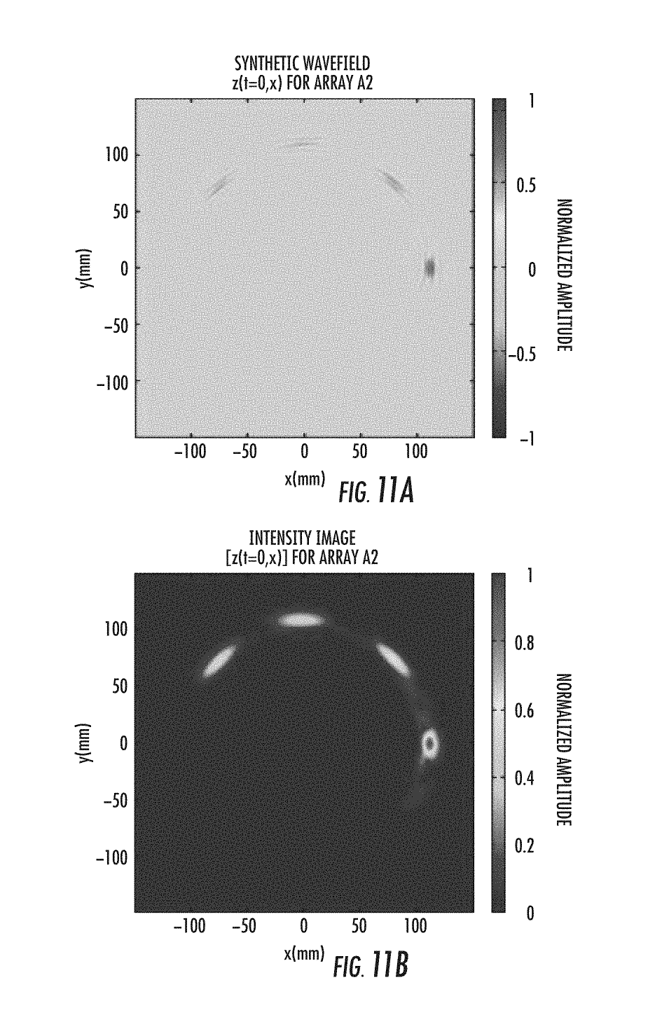

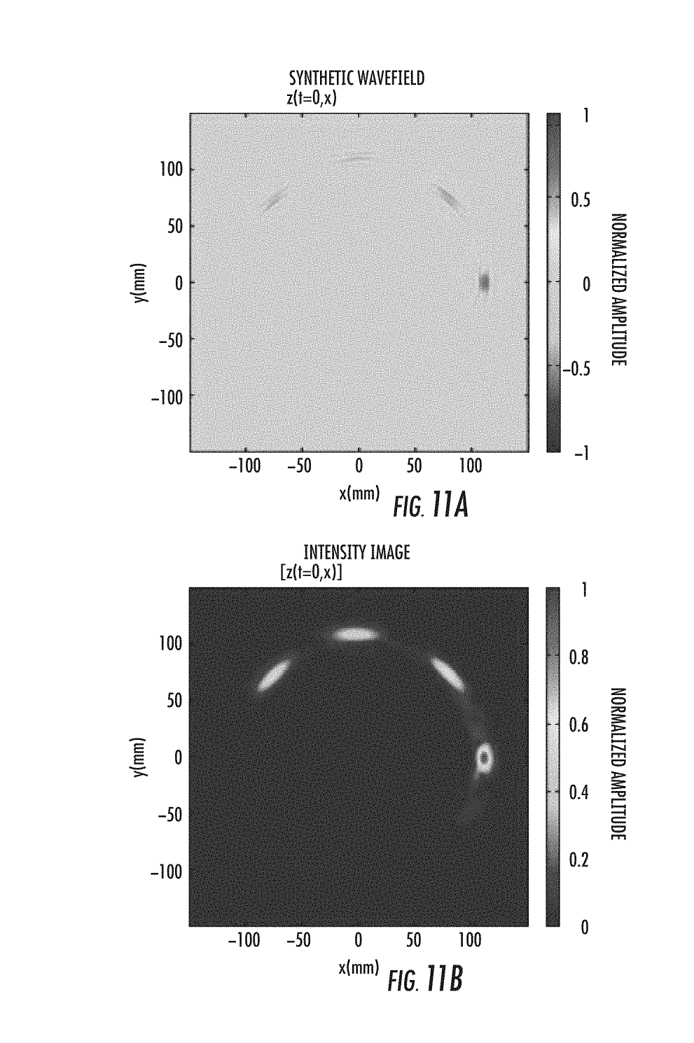

FIG. 10A depicts an example SLDV wavefield measurement 510 at 30 microseconds. FIG. 10B depicts an example SLDV wavefield measurement 520 at 145 microseconds. In particular, measurement 510 depicts incident waves generated from the actuator and measurement 520 depicts reflection waves from the four defects of FIG. 9B. For identifying the wave mode, the wavenumber spectra of these wavefields can be obtained by frequency-wave number analysis. Theoretical wavenumber curve of A₀ mode at 30 microseconds is further depicted in FIG. 10C. Theoretical wavenumber curve of A₀ mode at 145 microseconds is depicted in FIG. 10D. As shown, both spectra show their wavenumber components are on the curve of A₀ mode.

FIGS. 11A and 11B depicts example beamforming and imaging results for a 21×21 array. FIG. 11A depicts a synthetic wavefield for the array. FIG. 11B depicts an intensity image for the array. As shown, FIGS. 11A and 11B depict four highlighted regions, which are indicative of the presence of four defects at various locations corresponding to the highlighted regions.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A system for evaluating an anisotropic composite material, the system comprising:
a guided wave source configured to provide one or more guided waves to the anisotropic composite material;
a function generator configured to provide one or more signals to the guided wave source to generate the one or more guided waves;
at least one sensor configured to measure a property of the one or more guided waves in the anisotropic composite material;
one or more processors configured to receive output signals from the at least one sensor associated with measured properties of the one or more guided waves, wherein the one or more processors are configured to construct a phased array of a plurality of output signals associated with different locations on the anisotropic composite material;
wherein the one or more processors are configured to generate a directional output beam associated with phased array based at least in part on a direction dependent guided wave parameter.

2. The system of claim 1, wherein the phased array is a rectangular array.

3. The system of claim 1, wherein the sensor is a scanning laser Doppler vibrometer.

4. The system of claim 3, wherein the property is a guided wave velocity along a laser beam.

5. The system of claim 1, wherein the one or more processors are configured to generate a directional output beam associated with phased array based at least in part on a direction dependent guided wave parameter by implementing a delay in the one or more output signals to generate the directional output beam.

6. The system of claim 5, wherein the delay is implemented as a time delay in a time domain.

7. The system of claim 5, wherein the delay is implemented as a phase shift in a phase domain.

8. The system of claim 1, wherein the one or more processors are configured to generate a directional output beam associated with phased array based at least in part on a direction dependent guided wave parameter at least in part by implementing a weighting factor in the one or more output signals to generate the directional output beam.

9. The system of claim 1, wherein the one or more processors are configured to generate a directional output beam associated with phased array based at least in part on a direction dependent guided wave parameter at least in part by implementing a beamforming factor in the one or more output signals.

10. The system of claim 1, wherein the guided wave source is lead zerconate titinate (PZT) material.

11. The system of claim 1, wherein the function generator is configured to provide a signal with a frequency of about 120 kHz to the guided wave source.

12. The system of claim 1, wherein the sensor is configured to measure a property associated with a reflection wave reflected from a defect in the anisotropic composite material

13. The system of claim 1, wherein the anisotropic composite material comprises a carbon fiber reinforced composite material.

14. A method for evaluating an anisotropic composite material, the method comprising:
providing one or more guided waves through an anisotropic composite material;
obtaining output signals from at least one sensor, the output signals associated with measured properties of the one or more guided waves, each output signal associated with a different location on the anisotropic composite material to form a phased array of a plurality of output signals; and
implementing a delay in one or more of the output signals to generate the directional output beam for the phased array.

15. The method of claim 14, wherein the delay is implemented as a time delay in a time domain.

16. The method of claim 14, wherein the delay is implemented as a phase shift in a phase domain.

17. The method of claim 14, wherein the method comprises implementing a weighting factor in the one or more output signals to generate the directional output beam.

18. The method of claim 14, wherein the method comprises implementing a beamforming factor in the one or more output signals.

19. The method of claim 14, wherein the phased array is a rectangular array.

20. The method of claim 14, wherein one or more of the output signals are associated with a property of a reflection wave reflected from a defect in the anisoptropic composite material.
